(19) United States
(12) Patent Application Publication
(10) Pub. No.: US 2012/0196974 A1
(43) Pub. Date: Aug. 2, 2012

(54) CURED PERFLUOROELASTOMER DIAPHRAGM

(75) Inventors: KAORI IWAMOTO, TOCHIGI (JP); BUNICHI RAI, TOKYO (JP)

(73) Assignee: E. I. DU PONT DE NEMOURS AND COMPANY, Wilmington, DE (US)

(21) Appl. No.: 13/204,792

(22) Filed: Aug. 8, 2011

Related U.S. Application Data
(60) Provisional application No. 61/376,703, filed on Aug. 25, 2010.

(51) Int. Cl. C08L 33/22; C08K 3/04

(52) U.S. Cl. 524/546

(57) ABSTRACT

A cured perfluoroelastomer diaphragm comprises A) perfluoroelastomer and B) 10 to 50 parts by weight, per hundred parts by weight perfluoroelastomer, of carbon black a nitrogen adsorption specific area of 70-150 m²/g and a dibutyl phthalate absorption of 90-180 ml/100 g.

### CROSS-REFERENCE TO RELATED APPLICATIONS

This application claims the benefit of U.S. Provisional Application No. 61/376,703 filed Aug. 25, 2010.

### FIELD OF THE INVENTION

This invention pertains to a cured perfluoroelastomer diaphragm seal comprising perfluoroelastomer and 10 to 50 parts by weight, per hundred parts by weight perfluoroelastomer, of carbon black having a nitrogen adsorption specific area (N2SA) of 70-150 m²/g and a dibutyl phthalate (DBP) absorption of 90-180 ml/100 g.

### BACKGROUND OF THE INVENTION

Elastomeric perfluoropolymers (i.e. perfluoroelastomers) exhibit excellent resistance to the effects of heat, weather, oil, solvents and chemicals. Such materials are commercially available and are most commonly copolymers of tetrafluoroethylene (TFE) with a perfluoro(alkyl vinyl ether) such as perfluoro(methyl vinyl ether) (PMVE). Often, these perfluoroelastomers also contain copolymerized units of a cure site monomer to facilitate vulcanization.

Perfluoroelastomer compositions are typically filled with either a black (e.g. carbon black) or white (e.g. barium sulfate) filler in order to optimize tensile properties. Medium thermal (MT) carbon black such as N990 is a popular filler.

Cured perfluoroelastomer articles are often used in high temperature environments. Thus, the articles must have good elongation at break and good tensile strength at high temperatures, e.g. 200° C.

### SUMMARY OF THE INVENTION

An aspect of the invention is a cured perfluoroelastomer diaphragm comprising A) perfluoroelastomer and B) 10 to 50 parts by weight, per hundred parts by weight perfluoroelastomer, of carbon black having a nitrogen adsorption specific area of 70-150 m²/g and a dibutyl phthalate absorption of 90-180 ml/100 g.

### DETAILED DESCRIPTION OF THE INVENTION

The perfluoroelastomers employed in the cured articles of the present invention are capable of undergoing crosslinking reactions with any of the known curatives for perfluoroelastomers such as, but not limited to the combination of organic peroxides and polyfunctional coagents (U.S. Pat. Nos. 4,214,060; 4,983,680), organotin (U.S. Pat. No. 5,789,489), bis(aminophenols) such as diaminobisphenol AF (U.S. Pat. No. 6,211,319 B1), aromatic tetraamines such as 3,3′-diaminobenzidene, and ammonia generating compounds such as urea and other compounds disclosed in U.S. Pat. No. 6,281,296 and WO 01/27194.

Perfluoroelastomers which may be employed in this invention are based on copolymerized units of tetrafluoroethylene (TFE), a perfluoro(alkyl vinyl ether) (PAVE) and a cure site monomer.

Perfluoro(alkyl vinyl ethers) (PAVE) suitable for use as monomers include those of the formula

CF₂=CFO(R_{f′}O)ₙ(R_{f″}O)ₘR_{f} (I)

where R_{f}′, and R_{f}′ are different linear or branched perfluoroalkylene groups of 2-6 carbon atoms, m and n are independently 0-10, and R_{f} is a perfluoroalkyl group of 1-6 carbon atoms.

A preferred class of perfluoro(alkyl vinyl ethers) includes compositions of the formula

CF₂=CFO(CF₂CFXO)ₙR_{f} (II)

where X is F or CF₃, n is 0-5, and R_{f} is a perfluoroalkyl group of 1-6 carbon atoms. A most preferred class of perfluoro(alkyl vinyl ethers) includes those ethers wherein n is 0 or 1 and R_{f} contains 1-3 carbon atoms. Examples of such perfluorinated ethers include perfluoro(methyl vinyl ether) (PMVE) and perfluoro(propyl vinyl ether) (PPVE). Other useful monomers include compounds of the formula

CF₂=CFO[(CF₂)ₘCF₂CFZO]ₙR_{f} (III)

where R_{f} is a perfluoroalkyl group having 1-6 carbon atoms,
m=0 or 1, n=0-5, and Z=F or CF₃. Preferred members of this class are those in which R_{f} is CF₃, m=1, n=1, and Z=F; and R_{f} is C₃F₇, m=0, and n=1.

Additional perfluoro(alkyl vinyl ether) monomers include compounds of the formula

CF₂=CFO[(CF₂CF{CF₃}O)ₙ(CF₂CF₂CF₂O)ₘ(CF₂)ₚ]CₓF₂ₓ₊₁ (IV)

where m and n independently=0-10, p=0-3, and x=1-5. Preferred members of this class include compounds where n=0-1, m=0-1, and x=1.

Additional examples of useful perfluoro(alkyl vinyl ethers) include

CF₂=CFOCF₂CF(CF₃)O(CF₂O)ₘCₙF₂ₙ₊₁ (V)

where n=1-5, m=1-3, and where, preferably, n=1. Perfluoro(methyl vinyl ether) (PMVE) is the most preferred PAVE for use in the perfluoroelastomer that are employed in this invention.

Suitable cure sites for crosslinking by organic peroxide/polyfunctional coagent curing systems include, but are not limited to bromine endgroups, iodine endgroups, or a combination thereof. Such cure sites may be introduced to the perfluoroelastomer polymer chain by polymerization in the presence of a bromine- or iodine-containing chain transfer agent (U.S. Pat. No. 4,243,770). Cure sites may also be introduced by copolymerization of the fluoroelastomer with cure site monomers that contain a bromine or iodine atom such as fluorinated olefins or fluorinated vinyl ethers. Such cure site monomers are well known in the art (e.g. U.S. Pat. Nos. 4,214,060; 5,214,106; and 5,717,036). Specific examples include, but are not limited to bromotrifluoroethylene (BTFE); 4-bromo-3,3,4,4-tetrafluorobutene-1 (BTFB); and 4-iodo-3,3,4,4-tetrafluorobutene-1 (ITFB). Bis-olefins may also be employed as cure site monomers in peroxide curable fluoroelastomers (U.S. Pat. No. 5,585,449).

Suitable cure sites for crosslinking by organic peroxide/polyfunctional coagent, organotin, diaminobisphenol AF, 3,3′-diaminobenzidinene, or ammonia generating curatives include, but are not limited to comonomers that contain a pendant nitrile group such as certain fluorovinyl ethers or fluoroolefins. Specific examples include perfluoro(8-cyano-5-methyl-3,6-dioxa-1-octene) (8-CNVE) and the nitrile-containing cure site monomers disclosed in U.S. Pat. No. 6,211,319 B1.

The perfluoroelastomers that may be employed in the compositions of this invention comprise copolymerized units of i) 40 to 55 (preferably 43 to 50) mole percent perfluoro(alkyl vinyl ether) and ii) 0.1 to 3.0 (preferably 0.3 to 2.0) mole percent cure site monomer. The remaining units being tetrafluoroethylene so that the total mole percent is 100. Most preferably the perfluoro(alkyl vinyl ether) is perfluoro(methyl vinyl ether) and the cure site monomer is perfluorinated vinyl ether or perfluorinated olefin that contains a pendent nitrile group.

One curing agent that may be employed is an organic peroxide/polyfunctional coagent system. Useful organic peroxides are those which generate free radicals at curing temperatures. A dialkyl peroxide or a bis(dialkyl peroxide) which decomposes at a temperature above 50° C. is especially preferred. In many cases it is preferred to use a ditertiarybutyl peroxide having a tertiary carbon atom attached to a peroxy oxygen. Among the most useful peroxides of this type are 2,5-dimethyl-2,5-di(tertiarybutylperoxy) hexyne-3 and 2,5-dimethyl-2,5-di(tertiarybutylperoxy)-hexane. Other peroxides can be selected from such compounds as dicumyl peroxide, dibenzoyl peroxide, tertiarybutyl perbenzoate, and di[1,3-dimethyl-3-(t-butylperoxy)butyl]carbonate.

The polyfunctional coagent employed with an organic peroxide is a polyunsaturated compound that is capable of cooperating with the peroxide to provide a useful cure. The coagent may be one or more of the following compounds: triallyl cyanurate; triallyl isocyanurate; tri(methallyl)isocyanurate; tris(diallylamine)-s-triazine; triallyl phosphite; N,N-diallyl acrylamide; hexaallyl phosphoramide; N,N,N′,N′-tetraalkyl tetraphthalamide; N,N,N′,N′-tetraallyl malonamide; trivinyl isocyanurate; 2,4,6-trivinyl methyltrisiloxane; and tri(5-norbornene-2-methylene) cyanurate. Particularly useful is triallyl isocyanurate (TAIC).

Other curatives which may be employed in the compositions of the invention include bis(aminophenols) such as diaminobisphenol AF, tetraamines, organotin and compounds which decompose to produce ammonia at curing temperatures, e.g. urea.

The carbon black filler employed in this invention is a highly reinforcing, high structure black having a nitrogen adsorption specific surface area (ASTM D-6556) of 70-150 m²/g and a dibutylphthalate (“DBP”) absorption (ASTM D-2414) of 90-180 ml/100g. Examples of such types of carbon black include, but are not limited to HAF (ASTM N330), ISAF (ASTM N220) and SAF (ASTM N110). HAF is preferred. Mixtures of various carbon blacks may be employed.

The amount of carbon black employed in the cured articles of this invention is 10 to 50 (preferably 15 to 30) parts by weight per hundred parts by weight perfluoroelastomer.

Perfluoroelastomer and the selected highly reinforcing carbon black are combined in an internal mixer (e.g. Banbury®, Kneader or Intermix®). Internal mixers lack sufficient shear deformation in their inherent design to incorporate fine filler pigment with low fluidity perfluoroelastomer polymer. However, it has been discovered that the low shear deformation may be compensated for by premixing the perfluoroelastomer polymer alone in an internal mixer until the polymer temperature reaches at least 90° C. (preferably at least 100° C.). The highly reinforcing carbon black can then be added to the hot perfluoroelastomer polymer. The formation of firm filler gel may be achieved by application of high shear rate and high temperature. For the proper formation of firm filler gel, the maximum mixing temperature is between 150° C. and 180° C., preferably between 155° C. and 170° C. The mixer rotor is set between 20 and 80 (preferably 30-60) revolutions per minute (rpm) so that the average shear rate is 500 -2500 (preferably 1000-2000) s^{-1.}

When a peroxide curing system is employed to crosslink the articles of this invention, the level of multifunctional coagent (e.g. triallyl isocyanurate) is 0.3-1.3, preferably 0.5-1.0, parts by weight, per hundred parts by weight perfluoroelastomer. The level of peroxide is 0.25-2, preferably 0.7-1.5, parts by weight, per hundred parts by weight perfluoroelastomer.

When a curative other than peroxide (e.g. diaminobisphenol AF) is employed to crosslink the articles of this invention, the curative level is 0.8-1.8, preferably 1.0-1.5, parts by weight per hundred parts by weight fluoroelastomer. The level of accelerator (e.g. a quaternary ammonium or phosphonium salt) is typically 0.2-1.0, preferably 0.4-0.8, parts by weight, per hundred parts by weight perfluoroelastomer.

Curative is added to the perfluoroelastomer and carbon black mixture at a temperature below 120° C. in order to prevent premature vulcanization. The compound is then shaped and cured in order to manufacture the cured article of the invention.

Optionally, the diaphragm of the invention may contain further ingredients commonly employed in the rubber industry such as process aids, colorants, acid acceptors, etc.

Cured (i.e. crosslinked) perfluoroelastomer diaphragms of this invention have an excellent combination of tensile strength and elongation at break at high temperature. Tensile strength at break (Tb), measured at 200° C., is at least 3 MPa, preferably at least 3.5 MPa. Elongation at break, measured at 200° C., is a least 90%, preferably at least 100%.

Other cured perfluoroelastomer articles that would benefit from the above-described perfluoroelastomer/carbon black compositions include a cured gas chromatography injection port septum, peristaltic pump tubing, gate valve seals for use in semiconductor manufacturing equipment and o-rings having improved resistance to explosive decompression for applications such as down hole drilling.

### EXAMPLES

### Test Methods

Tensile properties JIS K 6251

The invention is further illustrated by, but is not limited to, the following examples.

### Example 1 and Comparative Example A

A perfluoroelastomer comprising copolymerized units of tetrafluoroethylene, perfluoro(methyl vinyl ether) and perfluoro(8-cyano-5-methyl-3,6-dioxa-1-octene) was prepared according to the process disclosed in U.S. Pat. No. 5,877,264. Blends of perfluoroelastomer and carbon black were made in a 1.0 L Kneader internal mixer. First, perfluoroelastomer was added to the mixing chamber and mixing was begun. After polymer temperature was at least 90° C., ingredients, except for curative, were added. Mixing was at a rotor speed of 30-70 rpm for several minutes. Once the compound temperature was above 150° C., the compound was dumped. A band of compound was then made on a roll mill and the curative system was added.

Carbon black employed in the composition of the invention (Example 1) was HAF (ASTM N330), available from Tokai Carbon Co., Ltd. It had a nitrogen adsorption specific area of 78 m²/g and a dibutyl phthalate absorption of 102 ml/100 g.

Carbon black employed in the comparative composition (Comparative Example A) was MT (ASTM N990), available from Engineered Carbons Inc. It had a nitrogen adsorption specific area of 8 m²/g and a dibutyl phthalate absorption of 43 ml/100 g.

O-rings were made for physical property testing. The o-rings were press cured at 180° C. for 6 minutes, followed by an oven post cure (air) at 230° C. for 8 hours.

Formulations, tensile strength at break (Tb) and elongation at break (Eb) are shown in the following Table.

TABLE

| | Example 1 | Comparative Example A |
|---|---|---|
| Formulation, phr¹ | | |
| Perfluoroelastomer | 100 | 100 |
| HAF (N330) | 20 | 0 |
| MT (N990) | 0 | 15 |
| Coagent² | 0.6 | 0 |
| Coagent³ | 0 | 2.4 |
| Peroxide⁴ | 0.5 | 0 |
| Peroxide⁵ | 0 | 3.6 |
| Physical properties | | |
| Eb @200° C., % | 116 | 55 |
| Tb @200° C., MPa | 3.7 | 2.0 |

¹parts by weight ingredient per hundred parts by weight rubber
²Diak #7, available from DuPont
³Diak #8, available from DuPont
⁴Perhexa 25B 40, available from NOF Corporation
⁵68% dialkyl peroxide on an inert carrier

What is claimed is:

1. A cured perfluoroelastomer diaphragm comprising A) perfluoroelastomer and B) 10 to 50 parts by weight, per hundred parts by weight perfluoroelastomer, of carbon black having a nitrogen adsorption specific area of 70-150 m²/g and a dibutyl phthalate absorption of 90-180 ml/100 g.

2. The perfluoroelastomer diaphragm of claim 1 wherein said carbon black is selected from the group consisting of ASTM N330, ASTM N220 and ASTM N110.

3. The perfluoroelastomer diaphragm of claim 2 wherein said carbon black is ASTM N330.

4. The perfluoroelastomer diaphragm of claim 1 wherein said diaphragm has an elongation at break of at least 90% at 200° C. and a tensile strength at break of at least 3 MPa at 200° C.
